(19) United States
(12) Patent Application Publication
(10) Pub. No.: US 2026/0034822 A1
(43) Pub. Date: Feb. 5, 2026

(54) MANUFACTURING METHOD FOR PRINTED MATTER AND PRINTING SYSTEM

(71) Applicant: MIMAKI ENGINEERING CO., LTD., Nagano (JP)

(72) Inventors: Ryo Nishizawa, Nagano (JP); Keisuke Okino, Nagano (JP); Kazuki Ohara, Nagano (JP)

(73) Assignee: MIMAKI ENGINEERING CO., LTD., Nagano (JP)

(21) Appl. No.: 19/196,747

(22) Filed: May 2, 2025

(30) Foreign Application Priority Data
Aug. 1, 2024 (JP) 2024-126223

(51) Int. Cl. B41M 7/00; B41J 11/00; B41J 15/04; B41J 25/00; B41M 3/00; C09D 11/101; C09D 11/30

(52) U.S. Cl. CPC B41M 7/0081; B41J 11/00214; B41J 15/04; B41J 25/001; B41M 3/008; C09D 11/101; C09D 11/30

(57) ABSTRACT

A manufacturing method for a printed matter creates a printed matter in which a functional powder-containing liquid containing a functional powder is applied to at least a part of a medium, the manufacturing method including: a post-application medium preparing step of preparing a post-application medium that is the medium on which an application film of the functional powder-containing liquid is at least partially formed; an on-application-film ink layer forming step of forming an image layer to be an on-application-film ink layer by ejecting ink onto the application film using a printing apparatus; and a translucent layer forming step of forming a translucent layer that is a layer with translucency covering the image layer. In the on-application-film ink layer forming step, the printing apparatus is caused to form the image layer under a print condition to cure the ink in a matte tone by the curing unit.

### CROSS REFERENCE TO RELATED APPLICATIONS

This application claims the priority benefit of Japanese Patent Application No. 2024-126223, filed on Aug. 1, 2024. The entirety of the above-mentioned patent application is hereby incorporated by reference herein and made a part of this specification.

### TECHNICAL FIELD

The present disclosure relates to a manufacturing method for a printed matter and a printing system.

### DESCRIPTION OF THE BACKGROUND ART

A conventional method for performing screen printing using a pearl ink containing a pearl pigment is known (see, for example, Japanese Unexamined Patent Publication No. 2006-159536.). Japanese Unexamined Patent Publication No. 2006-159536 discloses that a pearl print layer is formed using a pearl ink by screen printing on matte paper having printability with an inkjet printer, and an image layer is formed by the inkjet printer.

In a case where a powder (functional powder) having functionality such as a pearl pigment is used, the pigment (powder) has a large size (particle size), which may affect a design to be expressed. Therefore, in a case where a design is expressed on a printed matter using an application liquid containing the pearl pigment or the like, there is a demand for creating the printed matter by an appropriate method. The present disclosure provides a manufacturing method for a printed matter and a printing system.

The inventors of the present application have conducted intensive studies on a method for performing printing on a medium to which a functional powder-containing liquid that is a liquid containing a functional powder such as a pearl pigment is at least partially applied. The inventors have found that when a layer of ink is formed on an application film of the functional powder-containing liquid on the medium in this case, the layer of ink is affected by the state of the application film as a base, which may make it difficult to express a desired design. More specifically, for example, in a case where a pearl application liquid containing a pearl pigment is used as the functional powder-containing liquid, it is considered that the surface of the medium (the surface of the application film) after application of the pearl application liquid becomes rough due to the pearl pigment having a large size (particle size). In this case, for example, even if ink dots landed on the application film are sufficiently leveled in the operation of forming the layer of ink on the application film, the surface of the layer of ink is likely to become rough. As a result, for example, regarding the state of the application film seen through the layer of ink, glitter and gloss peculiar to the pearl pigment may be lost, and a design using the pearl application liquid may not be able to be appropriately expressed.

Meanwhile, through further intensive studies, the inventors of the present application have thought of forming the layer of ink formed on the application film of the functional powder-containing liquid by inkjet method, intentionally curing the ink in a matte tone, and further forming thereon a translucent layer that is a layer having translucency. By actually performing various experiments and the like, it has been confirmed that such a method makes it possible to more appropriately express a desired design even in a case where the surface of the application film of the functional powder-containing liquid is rough. The inventors of the present application have further found features necessary for obtaining such an effect, and have achieved the present disclosure.

### SUMMARY

An embodiment of the present disclosure provides a manufacturing method for a printed matter to create a printed matter in which a functional powder-containing liquid that is a liquid containing a functional powder that is a powder having a predetermined function is applied to at least a part of a medium, the manufacturing method including: a post-application medium preparing step of preparing a post-application medium that is the medium on which an application film that is a film formed by applying the functional powder-containing liquid is at least partially formed; an on-application-film ink layer forming step of forming an on-application-film ink layer that is a layer of ink stacked on the application film by ejecting ink onto the application film using a printing apparatus; and a translucent layer forming step of forming a translucent layer that is a layer with translucency covering the on-application-film ink layer, in which the printing apparatus includes an inkjet head that ejects ink by inkjet method, and a curing unit that cures the ink ejected by the inkjet head, and in the on-application-film ink layer forming step, the printing apparatus is caused to form the on-application-film ink layer under a print condition to cure the ink ejected by the inkjet head in a matte tone by the curing unit.

### BRIEF DESCRIPTION OF THE DRAWINGS

FIGS. 1A and 1B are drawings illustrating a printing system 10 that executes a manufacturing method for a printed matter according to an embodiment of the present disclosure; FIG. 1A illustrates a configuration example of the printing system 10; FIG. 1B illustrates a configuration example of an application liquid ejection apparatus 14.

FIGS. 2A and 2B are drawings illustrating a more detailed configuration and the like of a printing apparatus 12; FIG. 2A illustrates a configuration example of the printing apparatus 12;

FIG. 2B illustrates a configuration example of a head unit 102 in the printing apparatus 12.

FIG. 3 is a drawing illustrating an example of processing performed on a medium 50 in the printing system 10.

### DETAILED DESCRIPTION OF EMBODIMENTS

The present disclosure is a manufacturing method for a printed matter to create a printed matter in which a functional powder-containing liquid that is a liquid containing a functional powder that is a powder having a predetermined function is applied to at least a part of a medium, the manufacturing method including: a post-application medium preparing step of preparing a post-application medium that is the medium on which an application film that is a film formed by applying the functional powder-containing liquid is at least partially formed; an on-application-film ink layer forming step of forming an on-application-film ink layer that is a layer of ink stacked on the application film by ejecting ink onto the application film using a printing apparatus; and a translucent layer forming step of forming a translucent layer that is a layer with translucency covering the on-application-film ink layer, in which the printing apparatus includes an inkjet head that ejects ink by inkjet method, and a curing unit that cures the ink ejected by the inkjet head, and in the on-application-film ink layer forming step, the printing apparatus is caused to form the on-application-film ink layer under a print condition to cure the ink ejected by the inkjet head in a matte tone by the curing unit.

With such a configuration, for example, by forming the on-application-film ink layer on the application film of the functional powder-containing liquid, it is possible to create a printed matter with high designability in which a design expressed by the application film of the functional powder-containing liquid and a design expressed by the on-application-film ink layer are combined. In this case, by forming the on-application-film ink layer under the print condition to cure the ink in a matte tone and forming the translucent layer thereon, it is possible to appropriately create the printed matter with high designability while appropriately suppressing the influence of the surface state of the application film of the functional powder-containing liquid. In this configuration, the medium can be considered as, for example, a base material to which the functional powder-containing liquid is applied. In the post-application medium preparing step, for example, the functional powder-containing liquid is applied to the medium to prepare the medium on which the application film of the functional powder-containing liquid is at least partially formed. In the post-application medium preparing step, for example, a medium to which the functional powder-containing liquid is applied in advance may be prepared. Regarding the on-application-film ink layer forming step, curing the ink in a matte tone can be considered as, for example, curing ink dots formed with the ink landed on an ejection position without flattening the dots. For example, in a case where a matte-tone print condition and a glossy-tone print condition are prepared in advance in the printing apparatus, for example, the matte-tone print condition prepared in advance in the printing apparatus can be suitably used as the print condition to cure the ink in a matte tone.

For example, a pearl pigment can be suitably used as the functional powder. In this case, the functional powder-containing liquid can be considered as, for example, a pearl application liquid that is an application liquid containing the pearl pigment. For example, a known pigment having a particle size of about several tens um to several hundreds um can be suitably used as the pearl pigment. In this case, for example, the size of the pearl pigment in the application film of the pearl application liquid is large. Thus, even if the ink dots are leveled (flattened) at the time of forming the on-application-film ink layer, the surface of the on-application-film ink layer may become rough. Furthermore, in this case, for example, if the on-application-film ink layer is formed under the glossy-tone print condition to sufficiently flatten the ink dots, the ink dots may spread in an unintended direction during the flattening of the ink dots due to the influence of the rough surface of the application film of the pearl application liquid, and it may become difficult to appropriately form the layer of ink in a glossy tone. As a result, for example, a design to be expressed may be affected.

On the other hand, with the above configuration, the ink dots landed on the application film of the functional powder-containing liquid such as the pearl application liquid can be appropriately cured in a short time by forming the on-application-film ink layer under the print condition to cure the ink in a matte tone, for example. As a result, for example, even in a case where the surface of the application film of the functional powder-containing liquid is rough, the ink can be more appropriately cured in an intended state. Furthermore, in this case, the influence of the on-application-film ink layer formed in a matte tone can be reduced and a desired design can be more appropriately expressed by forming the translucent layer on the on-application-film ink layer, for example. More specifically, in this case, in the on-application-film ink layer forming step, the on-application-film ink layer is formed so that the application film of the functional powder-containing liquid is visually recognized through the on-application-film ink layer in at least a part of the on-application-film ink layer, for example. Then, in the translucent layer forming step, for example, the translucent layer is formed to reduce the influence of diffused reflection of light generated in the matte-tone on-application-film ink layer. With such a configuration, for example, the printed matter with high designability can be more appropriately created.

In this configuration, the inkjet head of the printing apparatus ejects, for example, an ultraviolet-curable ink that cures by irradiation with ultraviolet light. In this case, for example, an ultraviolet light source that generates ultraviolet light is used as the curing unit. The printing apparatus further includes, for example, a main scan driving unit that causes the inkjet head to perform a main scan of ejecting ink while relatively moving with respect to the medium in a main scanning direction set in advance. In this case, in the main scan, the ultraviolet light source emits ultraviolet light toward the medium while relatively moving with respect to the medium together with the inkjet head, for example. In the on-application-film ink layer forming step, the ultraviolet light source irradiates, for example, the ink ejected by the inkjet head in one main scan with ultraviolet light in the same main scan to cure the ink in a matte tone. With such a configuration, for example, the ink can be appropriately cured in a matte tone at the time of forming the on-application-film ink layer. In this case, curing the ink can be considered as, for example, curing the ink at least to a state in which the dots are not flattened anymore.

In this configuration, the printing apparatus includes, for example, an on-application-film ink layer head that is the inkjet head ejecting ink to be a material of the on-application-film ink layer, and a translucent layer head that is the inkjet head ejecting ink to be a material of the translucent layer. In this case, in the on-application-film ink layer forming step, for example, the ink ejected from the on-application-film ink layer head is cured in a matte tone by the curing unit to form the on-application-film ink layer. Then, in the translucent layer forming step, for example, the ink ejected from the translucent layer head is cured in a glossy tone by the curing unit to form the translucent layer. With such a configuration, for example, the printing apparatus can appropriately form the on-application-film ink layer and the translucent layer. Regarding the way of forming the translucent layer, curing the ink in a glossy tone can be considered as, for example, curing the ink after sufficiently flattening the ink dots formed with the ink landed on the on-application-film ink layer. Curing the ink in a glossy tone can also be considered as, for example, curing the ink under the glossy-tone print condition prepared in advance in the printing apparatus. It is conceivable to use, for example, the ultraviolet-curable ink as described above as the ink to be the material of the on-application-film ink layer. It is also conceivable to use, for example, the ultraviolet-curable ink as the ink to be the material of the translucent layer. It is conceivable to use, for example, a translucent ink as the ink to be the material of the translucent layer. In this case, for example, a clear ink, which is a colorless and translucent ink, can be suitably used as the ink to be the material of the translucent layer. In the printing apparatus, for example, one inkjet head may serve as both the on-application-film ink layer head and the translucent layer head. In this case, for example, it is conceivable to use a printing apparatus including a plurality of inkjet heads, and to make some of the inkjet heads serve as both the on-application-film ink layer head and the translucent layer head.

It is also conceivable to form the translucent layer by, for example, a method other than the method of forming the layer of ink with the printing apparatus. More specifically, in the translucent layer forming step, it is conceivable to form the translucent layer by, for example, applying a coating agent to be a material of the translucent layer onto the on-application-film ink layer. In this case, it is conceivable to apply the coating agent using, for example, an apparatus other than the printing apparatus or a tool. Also with such a configuration, for example, the translucent layer can be appropriately formed on the on-application-film ink layer. In this case, for example, a colorless and translucent clear coating agent can be suitably used as the coating agent. The translucent layer may be formed by sticking a film (thin film) such as a laminate film, for example. In this case, in the translucent layer forming step, the translucent layer is formed by, for example, sticking a translucent film on the on-application-film ink layer. Also with such a configuration, for example, the translucent layer can be appropriately formed on the on-application-film ink layer.

In a case where the printing apparatus forms the layer of ink on the medium on which the application film of the functional powder-containing liquid is formed, for example, instead of forming the layer of ink on the application film of the functional powder-containing liquid, the layer of ink may be formed on a side opposite to the surface of the medium on which the application film of the functional powder-containing liquid is formed. Also in this case, a design in which the application film of the functional powder-containing liquid and the layer of ink are combined can be expressed by using a translucent medium, for example. However, in this case, a problem may occur in the printing operation depending on the configuration of the printing apparatus, for example. More specifically, the printing apparatus includes, for example, a transporting mechanism that transports the medium.

In this case, in order to form the layer of ink on the side opposite to the surface of the medium on which the application film of the functional powder-containing liquid is formed, it is necessary to transport the medium with the surface on which the application film of the functional powder-containing liquid is formed facing downward, for example. Thus, in this case, for example, a frictional force generated between the medium and a table-shaped member supporting the medium increases, whereby transport failure such as occurrence of a jam is likely to be caused. The functional powder may fall off from the application film due to rubbing between the table-shaped member and the application film of the functional powder-containing liquid. On the other hand, in a case where the printing apparatus forms the layer of ink on the application film of the functional powder-containing liquid as described above, the medium can be more appropriately transported at the time of transporting the medium in the printing apparatus, for example. As the medium, for example, it is also conceivable to use a medium wound in a roll shape. In this case, the transporting mechanism in the printing apparatus unwinds and transports the medium from the medium wound in a roll shape, for example. With such a configuration, for example, even in the case of using the medium wound in a roll shape, it is possible to appropriately form the on-application-film ink layer on the application film of the functional powder-containing liquid while appropriately transporting the medium. It is also conceivable to adopt, for example, the configuration of a printing system having the same features as described above as the configuration of the present disclosure. Also in this case, for example, the same effects as described above can be obtained.

According to the present disclosure, for example, a printed matter with high designability can be appropriately created.

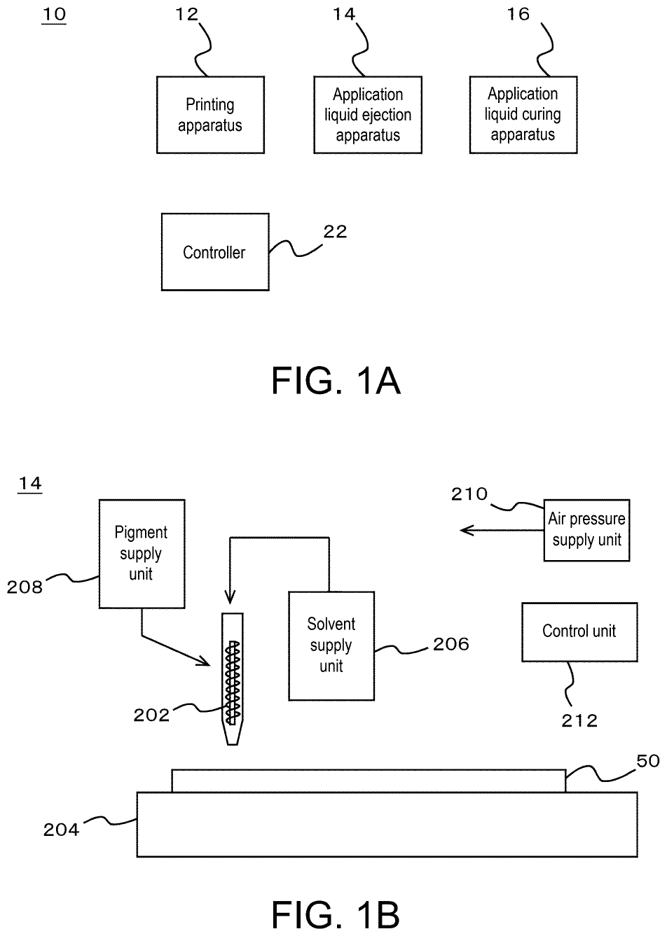

Hereinafter, an embodiment according to the present disclosure will be described with reference to the drawings. FIGS. 1A and 1B are drawings illustrating a printing system 10 that executes a manufacturing method for a printed matter according to an embodiment of the present disclosure. FIG. 1A illustrates a configuration example of the printing system 10. In the present embodiment, the printing system 10 is a system that creates a printed matter to which a pearl application liquid (pearl pigment-containing application liquid), which is a liquid containing a pearl pigment, is at least partially applied, and includes a printing apparatus 12, an application liquid ejection apparatus 14, an application liquid curing apparatus 16, and a controller 22. Other than the points described below, the printing system 10 and each unit of the printing system 10 may have features identical or similar to a known printing system and each unit thereof. In the present embodiment, the pearl pigment and the pearl application liquid are examples of an effect pigment and an effect pigment-containing liquid. The effect pigment and the effect pigment-containing liquid are examples of a functional powder and a functional powder-containing liquid. The functional powder can be considered as, for example, a powder having a predetermined function. The functional powder can also be considered as, for example, a functional pigment.

The functional powder-containing liquid can be considered as, for example, a liquid containing the functional powder. The effect pigment can be considered as, for example, a pigment that produces an effect by light interference or the like. The effect pigment-containing liquid can be considered as, for example, a liquid containing the effect pigment. The pearl pigment can be considered as, for example, a pigment exhibiting pearlescence by light interference or the like. For example, a known pearl pigment can be suitably used as the pearl pigment. The effect pigment such as the pearl pigment can also be considered as, for example, a pigment that develops color by interference of light of a specific wavelength.

The printing apparatus 12 is an inkjet printer including an inkjet head that ejects ink by inkjet method, and performs printing on a medium that is a printing target object by ejecting ink from the inkjet head. In this case, the printing apparatus 12 can be considered as forming a layer of ink on the medium. The ink ejected by the inkjet head can be considered as, for example, a liquid of a different color from the pearl application liquid. In the present embodiment, the printing apparatus 12 forms the layer of ink on an application film of the pearl application liquid by ejecting the ink to the medium to which the pearl application liquid is at least partially applied. The configuration, operation, and the like of the printing apparatus 12 will be described in more detail later.

The application liquid ejection apparatus 14 is an apparatus that ejects the pearl application liquid to the medium. The application liquid ejection apparatus 14 can be considered as, for example, an apparatus (pearl pigment application liquid applicator) that performs, on the medium, decoration other than printing executed by the printing apparatus 12. In the present embodiment, the application liquid ejection apparatus 14 applies the pearl application liquid to a medium before the printing apparatus 12 performs printing on the medium 50. As a result, the application liquid ejection apparatus 14 creates (prepares) the medium to which the pearl application liquid is at least partially applied. In this case, the medium can also be considered as, for example, a base material (application target object) to which the functional powder-containing liquid such as the pearl application liquid is applied. In the present embodiment, the application liquid ejection apparatus 14 ejects the pearl application liquid to an ejection position set in an application region that is a region where the pearl application liquid is applied in the medium. In this case, the pearl application liquid ejected to the ejection position is applied to the application region by gradually spreading in the application region. Therefore, the operation of ejecting the pearl application liquid to the ejection position by the application liquid ejection apparatus 14 can be considered as, for example, corresponding to the operation of applying the pearl application liquid to the application region. In the present embodiment, the application liquid ejection apparatus 14 ejects an ultraviolet-curable pearl application liquid that cures by irradiation with ultraviolet light. In this case, for example, after the pearl application liquid spreads in the application region, the pearl application liquid is irradiated with ultraviolet light, so that the pearl application liquid can be appropriately cured. The configuration, operation, and the like of the application liquid ejection apparatus 14 will also be described in more detail later. The application liquid curing apparatus 16 is an apparatus that cures the pearl application liquid ejected to the application region by the application liquid ejection apparatus 14. In the present embodiment, the application liquid curing apparatus 16 is an example of an ultraviolet irradiation unit. The application liquid curing apparatus 16 includes an ultraviolet light source such as a mercury lamp or UVLED, and cures the pearl application liquid by irradiating the pearl application liquid with ultraviolet light after the pearl application liquid spreads in the application region. As a result, the application liquid curing apparatus 16 fixes the pearl application liquid to the medium.

The controller 22 is configured to control each apparatus in the printing system 10. The controller 22 can be considered as, for example, a control part in the printing system 10. For example, a computer that executes a program for controlling each apparatus can be suitably used as the controller 22. In the present embodiment, the controller 22 determines a condition of printing (print condition) to be executed in the printing apparatus 12, a condition of application (application condition) of the pearl application liquid to be executed in the application liquid ejection apparatus 14 and the application liquid curing apparatus 16, and the like on the basis of a user's instruction or operation, for example. In this case, the controller 22 controls the operation of the printing apparatus 12 on the basis of the determined print condition. The controller 22 also controls the operations of the application liquid ejection apparatus 14 and the application liquid curing apparatus 16 on the basis of the determined application condition. According to the present embodiment, for example, it is possible to appropriately execute application of the pearl application liquid to the medium, printing of an image, and the like. In this case, for example, the application liquid ejection apparatus 14 applies the pearl application liquid to at least a part of the medium, and the inkjet head in the printing apparatus 12 draws an image on the medium, so that a printed matter with high designability can be appropriately created.

Next, the configurations, operations, and the like of the printing apparatus 12 and the application liquid ejection apparatus 14 will be described in more detail. For convenience of description, first, the configuration and operation of the application liquid ejection apparatus 14 will be described. FIG. 1B illustrates a configuration example of the application liquid ejection apparatus 14. In the present embodiment, the application liquid ejection apparatus 14 includes an ejection unit 202, a table unit 204, a solvent supply unit 206, a pigment supply unit 208, an air pressure supply unit 210, and a control unit 212. The ejection unit 202 is configured to eject the pearl application liquid to the medium 50. In the present embodiment, the ejection unit 202 is an example of a functional powder-containing liquid ejection unit and an effect pigment-containing liquid ejection unit. The ejection unit 202 generates the pearl application liquid by internally kneading a solvent supplied from the solvent supply unit 206 and the pearl pigment supplied from the pigment supply unit 208, and ejects the pearl application liquid from a nozzle (ejection nozzle) toward the medium 50. In this case, the ejection unit 202 can also be considered as, for example, an ejection head for the pearl application liquid having a kneader and a nozzle. The kneader can be considered as, for example, a portion where the pearl pigment and the solvent are kneaded at the preceding step of the nozzle. In the present embodiment, the ejection unit 202 includes the nozzle capable of adjusting a range in which the pearl application liquid to be ejected spreads, and changes the way of ejecting the pearl application liquid according to a user's instruction or operation, for example. More specifically, in the present embodiment, the ejection unit 202 switchingly executes spray ejection to eject the pearl application liquid in a spray form (mist form) over a wide range, and dispenser ejection to eject the pearl application liquid toward the ejection position in a range narrower than the spray ejection. In this case, the spray ejection can be considered as, for example, ejection for directly applying the pearl application liquid to a wide range. The dispenser ejection can be considered as, for example, ejection for applying the pearl application liquid to the application region by spreading the pearl application liquid ejected to the ejection position set in the application region to a region around the ejection position. The dispenser ejection can also be considered as, for example, ejection in which the ejected pearl pigment lands on the ejection position not in a spray form, but in a dripping form. For example, a known nozzle capable of switching between the spray ejection and the dispenser ejection can be suitably used as the nozzle of the ejection unit 202. In this case, for example, it is conceivable to change the way of ejection by switching the setting as to atomization/non-atomization in ejection. In this case, it is conceivable to appropriately adjust the range to spread the pearl application liquid by adjusting the atomization setting at the time of performing the spray ejection by the ejection unit 202. With such a configuration, the pearl application liquid can be ejected to the medium 50 by various methods. By using this ejection unit 202, the pearl application liquid can be more appropriately ejected, for example, even in the case of using a pearl pigment of a size that is difficult to eject by inkjet method (for example, a particle size greater than 50 μm).

In the present embodiment, the ejection unit 202 continuously ejects the pearl application liquid unlike, for example, ejection by inkjet method. In this case, the ejection unit 202 ejects the pearl application liquid by setting the amount of pearl application liquid ejected per unit time to a constant amount set in advance, for example. Continuously ejecting the pearl application liquid by the ejection unit 202 can be considered as, for example, continuously ejecting the pearl application liquid in the operation of ejecting a preset amount of pearl application liquid. In this case, the ejection unit 202 can also be considered as, for example, a configuration in which the amount of pearl application liquid ejected by one ejection to one ejection position is variable. The ejection unit 202 may also eject the pearl application liquid to a plurality of ejection positions in one application region, for example. In this case, the ejection unit 202 continuously ejects a preset amount of pearl application liquid to each ejection position, for example. The ejection unit 202 may continuously eject the total amount of pearl application liquid to the plurality of ejection positions while moving along a movement path passing through the plurality of ejection positions.

The table unit 204 is a table-shaped member that holds the medium 50 at a position facing the ejection unit 202. The solvent supply unit 206 is a supply unit that supplies the solvent of the pearl application liquid to the ejection unit 202. In the present embodiment, the solvent of the pearl application liquid is a colorless and transparent ultraviolet-curable liquid. Such a solvent can also be considered as, for example, a transparent application liquid. Regarding the solvent being colorless and transparent, it can be considered, for example, that the solvent is intentionally made colorless. For example, an ultraviolet-curable clear ink having an appropriately adjusted viscosity can be suitably used as such a solvent. The pigment supply unit 208 is a supply unit that supplies the pearl pigment to the ejection unit 202. As described above as well, for example, a known pearl pigment can be suitably used as the pearl pigment. More specifically, for example, a pigment in which the surface of mica is coated with titanium oxide, silica, or the like can be suitably used as the pearl pigment. In this case, for example, a scaly pearl pigment can be suitably used.

Here, in the present embodiment, the viscosity of the pearl application liquid generated by being kneaded with the pearl pigment is set to, for example, a viscosity at which the pearl application liquid gradually spreads with the lapse of time in the application region after being ejected to the ejection position. In this case, the viscosity of the pearl application liquid can be considered as, for example, a viscosity at which the ejection unit 202 can perform the spray ejection and the dispenser ejection, and in a case where the dispenser ejection is performed, the pearl application liquid ejected to the ejection position appropriately spreads in the application region. In this case, if the viscosity of the pearl application liquid is too high, for example, it becomes difficult for the ejection unit 202 to appropriately eject the pearl application liquid. If the viscosity of the pearl application liquid is too low, for example, it is considered that the pearl pigment cannot be pulled when the solvent spreads in the application region, and the pearl application liquid cannot be appropriately applied to the application region. Furthermore, in a case where the viscosity of the pearl application liquid is too low, for example, depositing of the pearl pigment easily occurs in the pearl application liquid. In a case where the pearl pigment is deposited in the pearl application liquid, it may be difficult to disperse the pearl pigment again even by stirring or the like after the depositing, for example. Therefore, the viscosity of the pearl application liquid is preferably set to, for example, a viscosity at which the depositing of the pearl pigment hardly occurs in a period from the kneading of the pearl pigment and the solvent to the ejection. In consideration of these points, it is conceivable to set the viscosity of the pearl application liquid to, for example, about 100 to 1000 cp (centipoise) (for example, about 50 to 5000 cp, preferably about 80 to 3000 cp). In this case, it is conceivable to set the viscosity of the solvent supplied from the solvent supply unit 206 to the ejection unit 202 to a viscosity corresponding to the viscosity of the pearl application liquid.

With such a configuration, the pearl application liquid can be appropriately generated by kneading the pearl pigment and the solvent in the ejection unit 202, for example. By using the pearl application liquid having such a viscosity, for example, the pearl application liquid can be appropriately applied to the application region, and the depositing of the pearl pigment in the pearl application liquid can be appropriately prevented. Furthermore, in this case, the viscosity of the solvent can be set to, for example, a viscosity at which the solvent is easily fed at the time of supply from the solvent supply unit 206 to the ejection unit 202 and the solvent is easily kneaded with the pearl pigment. Regarding the pearl pigment supplied from the pigment supply unit 208 to the ejection unit 202, it is conceivable to set the particle size of the pearl pigment to, for example, about several tens μm (for example, about 10 to 90 μm). By using such a pearl pigment, for example, the ejection unit 202 can appropriately create the pearl application liquid. It is conceivable to select the particle size of the pearl pigment according to, for example, required texture. The pigment supply unit 208 may supply a pearl pigment having a smaller particle size or a pearl pigment having a larger particle size to the ejection unit 202 according to, for example, required texture. More specifically, for example, in a case where it is desired to express silkiness by the pearl application liquid, it is conceivable to use a pearl pigment having a particle size of about 10 μm (for example, about 5 to 20 μm). For example, in a case where it is desired to express glitter by the pearl application liquid, it is conceivable to use a pearl pigment having a particle size of about several hundreds μm (for example, about 100 to 500 μm).

The air pressure supply unit 210 is configured to output positive-pressure air that is air having a pressure higher than the atmospheric pressure. In the present embodiment, the air pressure supply unit 210 supplies the positive-pressure air to the solvent supply unit 206 and the pigment supply unit 208 to move the solvent and the pearl pigment from the solvent supply unit 206 and the pigment supply unit 208 to the ejection unit 202. With such a configuration, for example, the solvent and the pearl pigment can be appropriately supplied from the solvent supply unit 206 and the pigment supply unit 208 to the ejection unit 202. In this case, the solvent or the like supplied from the solvent supply unit 206 to the ejection unit 202 can also be considered as, for example, transmitting the pressure of the air supplied from the air pressure supply unit 210 to the ejection unit 202. In this case, the air pressure supply unit 210 can also be considered as, for example, applying a pressure for causing the ejection unit 202 to eject the pearl application liquid to the ejection unit 202. The air pressure supply unit 210 may apply the pressure for causing the ejection unit 202 to eject the pearl application liquid to the ejection unit 202 without passing through the solvent supply unit 206 and the like. The control unit 212 includes, for example, a CPU of the application liquid ejection apparatus 14, and controls the operation of each unit of the application liquid ejection apparatus 14. According to the present embodiment, the application liquid ejection apparatus 14 can appropriately eject the pearl application liquid to the medium 50. In this case, the pearl application liquid can be appropriately applied to the medium 50 by curing the pearl application liquid by the application liquid curing apparatus 16 thereafter.

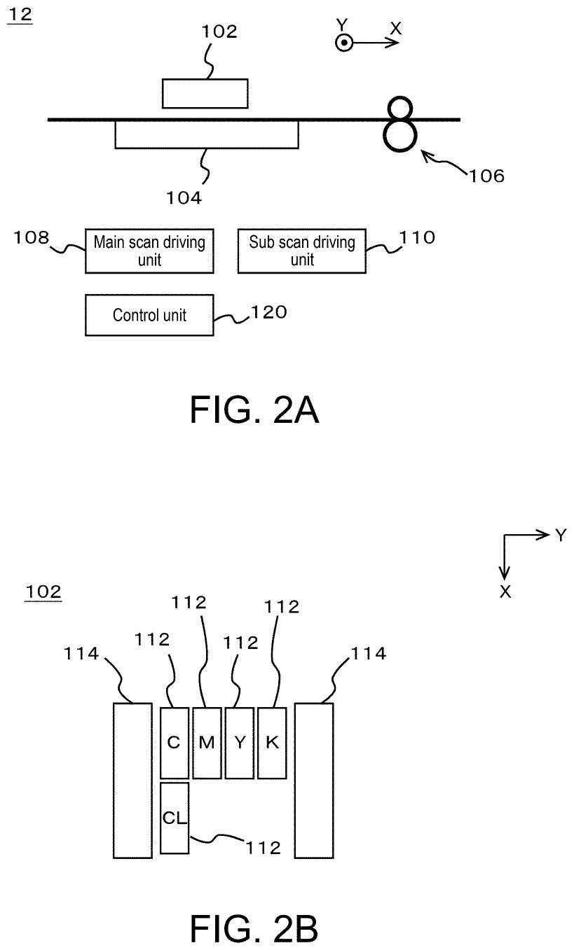

Next, the configuration and operation of the printing apparatus 12 will be described. FIGS. 2A and 2B are drawings illustrating a more detailed configuration and the like of the printing apparatus 12. FIG. 2A illustrates a configuration example of the printing apparatus 12. FIG. 2B illustrates a configuration example of a head unit 102 in the printing apparatus 12. In the present embodiment, the printing apparatus 12 includes the head unit 102, a table unit 104, a transporting mechanism 106, a main scan driving unit 108, a sub scan driving unit 110, and a control unit 120. The head unit 102 is a portion that ejects ink to the medium 50, and for example, as shown in FIG. 2B, includes a plurality of inkjet heads 112 and a plurality of ultraviolet light sources 114. The head unit 102 may further include a carriage or the like that holds these components. The plurality of inkjet heads 112 are ejection heads that eject ink by inkjet method, and for example, eject inks of different colors. In the present embodiment, the plurality of inkjet heads 112 eject an ultraviolet-curable ink (UV ink) that cures by irradiation with ultraviolet light. At least some of the plurality of inkjet heads 112 eject a color ink for color printing, for example. As the color ink, for example, it is conceivable to use an ink of each process color that is a basic color of color expression. As the ink of each process color, for example, it is conceivable to use inks of respective colors of cyan (C color), magenta (M color), yellow (Y color), and black (K color). More specifically, in the present embodiment, the head unit 102 includes the inkjet heads 112 for the respective colors of CMYK. The head unit 102 may further include an inkjet head 112 for a predetermined spot color in addition to the plurality of inkjet heads 112 for the respective process colors. The spot color can be considered as, for example, a color other than the process colors. More specifically, in the present embodiment, the head unit 102 includes an inkjet head 112 for a clear ink (CL) as the inkjet head 112 for the spot color. The clear ink can be considered as, for example, a colorless and translucent ink. The translucency can be considered as, for example, translucency for visible light. The head unit 102 may further include an inkjet head 112 for a spot color other than the clear ink. For example, the head unit 102 may further include an inkjet head 112 for a spot color such as white.

In the present embodiment, the inkjet heads 112 for the respective colors of CMYK and the inkjet head 112 for the clear ink are examples of an on-application-film ink layer head. The inkjet head 112 for the clear ink is an example of a translucent layer head. In this case, the on-application-film ink layer head can be considered as, for example, an inkjet head that ejects ink to be a material of an on-application-film ink layer that is a layer of ink stacked on the application film of the pearl application liquid. The translucent layer head can be considered as, for example, an inkjet head that ejects ink to be a material of the translucent layer that is a layer with translucency covering the on-application-film ink layer. In the present embodiment, the inkjet head 112 for the clear ink can be considered as, for example, serving as both the on-application-film ink layer head and the translucent layer head.

Any of the inkjet heads 112 other than that for the clear ink may also serve as both the on-application-film ink layer head and the translucent layer head according to a design to be expressed in a printed matter. As the inkjet head 112, for example, it is conceivable to use a configuration of ejecting inks of a plurality of colors. In this case, the inkjet head 112 that ejects inks of a plurality of colors can be considered as, for example, serving as a plurality of inkjet heads 112 for the plurality of colors. In the present embodiment, the inkjet heads 112 for the respective colors of CMYK are arranged in a main scanning direction (Y direction in FIGS. 2A and 2B) orthogonal to a sub scanning direction (X direction in FIGS. 2A and 2B) set in advance in the printing apparatus 12 with their positions in the sub scanning direction being aligned. The inkjet head 112 for the clear ink is disposed with its position in the sub scanning direction being shifted from those of the inkjet heads 112 for the respective colors of CMYK. In a modified example of the configuration of the head unit 102, the arrangement of the plurality of inkjet heads 112 may be different from the configuration shown in FIG. 2B. In the head unit 102, the plurality of ultraviolet light sources 114 are light sources that emit ultraviolet light to cure the ink ejected by the plurality of inkjet heads 112. In this case, curing the ink can be considered as, for example, curing the ink at least to a state in which the dots are not flattened anymore. For example, UVLED can be suitably used as the ultraviolet light sources 114. In the present embodiment, the ultraviolet light sources 114 are examples of a curing unit. The ultraviolet light sources 114 are disposed on one side and the other side in the main scanning direction with respect to the plurality of inkjet heads 112 so as to sandwich the plurality of inkjet heads 112 therebetween.

The table unit 104 is a table-shaped member that holds the medium 50 at a position facing the plurality of inkjet heads 112. The table unit 104 holds the medium 50 on which the application film of the pearl application liquid is at least partially formed in a direction in which the surface on which the application film of the pearl application liquid is formed faces the head unit 102. The transporting mechanism 106 is configured to transport the medium 50 at a position facing the head unit 102. The transporting mechanism 106 includes, for example, a plurality of rollers, and moves the medium 50 on the table unit 104 by rotating the rollers.

In this case, the transporting mechanism 106 can be considered as, for example, transporting the medium 50 in which the surface on which the application film of the pearl application liquid is formed faces the head unit 102. The transporting mechanism 106 can also be considered as, for example, transporting the medium 50 in a state in which the application film of the pearl application liquid on the medium 50 and the table unit 104 are not in contact with each other. With such a configuration, for example, the medium 50 on which the application film of the pearl application liquid is formed can be more appropriately transported.

The main scan driving unit 108 is a driving unit that causes the plurality of inkjet heads 112 in the head unit 102 to perform a main scan. The main scan can be considered as, for example, an operation of ejecting ink while relatively moving with respect to the medium 50 in the main scanning direction.

In the present embodiment, the main scan driving unit 108 causes the plurality of inkjet heads 112 to perform the main scan by moving the head unit 102 in the main scanning direction. In this case, the main scan driving unit 108 moves the plurality of ultraviolet light sources 114 in the main scanning direction together with the plurality of inkjet heads 112, and for example, causes the ultraviolet light sources 114 to emit ultraviolet light during the main scan to cure the ink landed on the medium 50. The operation of curing the ink by the ultraviolet light sources 114 will be described in more detail later. The sub scan driving unit 110 is a driving unit that causes the plurality of inkjet heads 112 to perform a sub scan. The sub scan can be considered as, for example, an operation of relatively moving with respect to the medium 50 in the sub scanning direction. The sub scan driving unit 110 changes a region to be a target of the main scan in the medium 50, for example, by causing the plurality of inkjet heads 112 to perform the sub scan between the main scans. The region to be the target of the main scan can be considered as, for example, a region where the ink can be ejected from the plurality of inkjet heads 112 in the main scan. The sub scan can be considered as, for example, a feeding operation to change the region to be the target of the main scan in the medium 50. In the present embodiment, the sub scan driving unit 110 relatively moves the plurality of inkjet heads 112 with respect to the medium 50 by causing the transporting mechanism 106 to transport the medium 50. As a result, the sub scan driving unit 110 causes the plurality of inkjet heads 112 to perform the sub scan. With such a configuration, for example, the plurality of inkjet heads 112 can be caused to appropriately eject the ink to each position of the medium 50. The control unit 120 includes, for example, a CPU of the printing apparatus 12, and controls the operation of each unit of the printing apparatus 12. According to the present embodiment, for example, the printing apparatus 12 can appropriately print a desired image or the like on the medium 50.

Here, the operation of curing the ink by the ultraviolet light sources 114 will be described in more detail. In the present embodiment, the printing apparatus 12 executes a printing operation on the medium 50 according to a print condition set on the basis of user's selection or instruction, for example. In the printing apparatus 12, for example, a matte-tone print condition and a glossy-tone print condition are prepared in advance regarding the way of curing the ink. In this case, the matte-tone print condition can be considered as, for example, a print condition to cure the ink ejected by the inkjet heads 112 in a matte tone by the ultraviolet light sources 114. The glossy-tone print condition can be considered as, for example, a print condition to cure the ink ejected by the inkjet heads 112 in a glossy tone by the ultraviolet light sources 114. Curing the ink in a matte tone can be considered as, for example, curing the ink dots formed with the ink landed on the ejection position without flattening the dots. Not flattening the ink dots can be considered as, for example, curing the ink dots before the ink dots are sufficiently flattened with the lapse of time. Sufficiently flattening the ink dots can be considered as, for example, bringing the ink dots into a state in which the ink dots can be regarded as being flattened in required printing quality. Curing the ink in a glossy tone can be considered as, for example, curing the ink after the ink dots formed with the ink landed on the ejection position are sufficiently flattened. Curing the ink in a glossy tone can also be considered as, for example, curing the ink after the lapse of a predetermined time for flattening the ink dots after the landing of the ink. The matte-tone and glossy-tone print conditions may be identical or similar to matte-tone and glossy-tone print conditions used in a known inkjet printer. In this case, curing the ink in a matte tone can be considered as, for example, curing the ink under the matte-tone print condition prepared in advance in the printing apparatus 12. Curing the ink in a glossy tone can be considered as, for example, curing the ink under the glossy-tone print condition prepared in advance in the printing apparatus 12.

More specifically, as described above as well, in the head unit 102 of the present embodiment, the ultraviolet light sources 114 are disposed on one side and the other side in the main scanning direction with respect to the plurality of inkjet heads 112. In the main scan, the ultraviolet light sources 114 move together with the inkjet heads 112. In this case, for example, it is conceivable to cure the ink ejected by the inkjet heads 112 during the main scan by ultraviolet light emitted from the ultraviolet light source 114 on the back side of the inkjet heads 112 in the moving direction of the inkjet heads 112 during the main scan. In this case, for example, the ink can be appropriately cured in a matte tone by curing the ink to a state in which the ink dots do not spread. Such a method of curing the ink can be considered as, for example, a method of curing the ink in a matte tone by irradiating the ink ejected by the inkjet heads 112 in one main scan with ultraviolet light in the same main scan from the ultraviolet light source 114 whose position in the sub scanning direction overlaps the inkjet heads 112.

In the present embodiment, in the case of curing the ink under the glossy-tone print condition, for example, it is conceivable that the curing of the ink ejected by the inkjet heads 112 in each main scan not be completed in the same main scan, and then the curing of the ink be completed after the ink dots are sufficiently flattened. More specifically, in this case, for example, after the inkjet heads 112 eject the ink during the main scan, it is conceivable to cause the ultraviolet light source 114 to pass through the region where the inkjet heads 112 have ejected the ink to complete the curing of the ink. In this case, for example, it is conceivable to complete the curing of the ink by moving the ultraviolet light source 114 similarly to that in the main scan while causing the ultraviolet light source 114 to emit ultraviolet light of intensity to complete the curing of the ink. With such a configuration, for example, the ink can be appropriately cured under the glossy-tone print condition. In this case, during the main scan, the ultraviolet light source 114 may emit ultraviolet light of intensity not enough to complete the curing of the ink. In this case, for example, it is conceivable to cause the ultraviolet light source 114 to emit ultraviolet light of intensity to increase the viscosity of the ink to a state in which smearing (for example, inter-color smearing) of the ink can be prevented and the flattening of the ink dots progresses with the lapse of time. With such a configuration, it is possible to appropriately cure the ink in a glossy tone while more appropriately preventing the occurrence of smearing, for example.

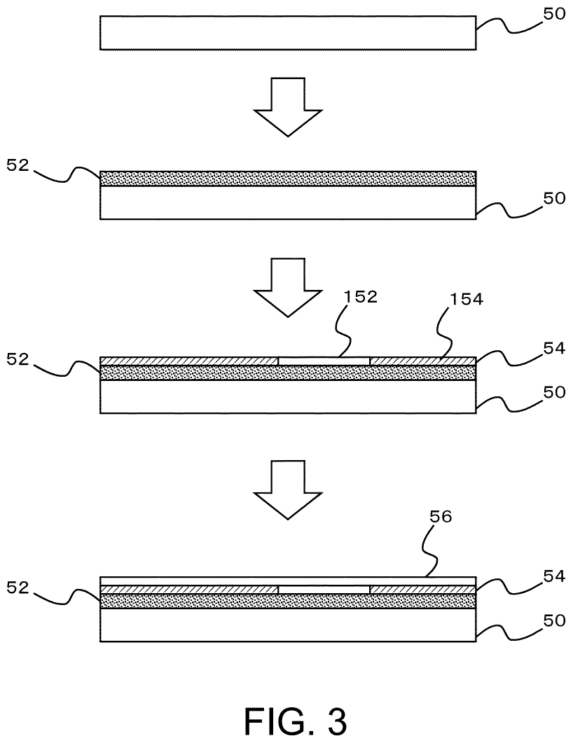

Next, processing and the like performed on the medium 50 in the printing system 10 (see FIG. 1A) of the present embodiment will be described in more detail. FIG. 3 illustrates an example of the processing performed on the medium 50 in the printing system 10. As described above as well, in the printing system 10 of the present embodiment, the application liquid ejection apparatus 14 and the application liquid curing apparatus 16 (see FIGS. 1A and 1B) form an application film 52 of the pearl application liquid on the medium 50, thereby preparing the medium 50 on which the application film 52 is at least partially formed. In this case, the application film 52 is an example of a film formed by applying the functional powder-containing liquid. The medium 50 on which the application film 52 is formed is an example of a post-application medium.

The operation of forming the application film 52 on the medium 50 by the application liquid ejection apparatus 14 and the application liquid curing apparatus 16 is an example of an operation in a post-application medium preparing step. In a modified example of the configuration of the printing system 10, for example, the medium 50 to which the pearl application liquid is applied in advance may be prepared instead of applying the pearl application liquid to the medium 50 in the printing system 10.

After the application film 52 is formed on the medium 50, an image layer 54, which is a layer of ink stacked on the application film 52, is formed by ejecting the ink onto the application film 52 using the printing apparatus 12 (see FIGS. 2A and 2B). In this case, the image layer 54 is an example of an on-application-film ink layer. The operation of forming the image layer 54 by the printing apparatus 12 is an example of an on-application-film ink layer forming step. In the present embodiment, the image layer 54 is a layer of ink that at least partially expresses an image. The image layer 54 can also be considered as, for example, a layer of ink for performing design expression by an image. More specifically, in the present embodiment, the printing apparatus 12 forms the image layer 54 having a transmission region 152 and an image region 154 on the application film 52. In this case, the transmission region 152 is a region formed to be translucent so that the application film 52 is visually recognized through the image layer 54. As the transmission region 152, for example, it is conceivable to form a colorless and transparent region formed with the clear ink. It is also conceivable to form a colored translucent region using the clear ink and a color ink (for example, an ink of any color of CMYK), as the transmission region 152. By forming the image layer 54 having the transmission region 152, for example, an observer observing the medium 50 can appropriately visually recognize at least a part of the application film 52 after the formation of the image layer 54. The image region 154 is a region where an image is drawn using a color ink. The image region 154 may be a region having lower translucency than the transmission region 152. By forming the image layer 54 having the transmission region 152 and the image region 154, it is possible to appropriately express, for example, a design in which a design expressed by the application film 52 visually recognized through the transmission region 152 and a design of the image drawn on the image layer 54 are combined. In the present embodiment, for example, it is conceivable that the application film 52 function as a background with respect to the image region 154. For example, a region having a certain degree of translucency may be formed as the image region 154. With such a configuration, for example, a design reflecting the state of the application film 52 as a background can be appropriately expressed in the image region 154.

In the present embodiment, the printing apparatus 12 forms the image layer 54 under the print condition to cure the ink ejected by the inkjet heads 112 (see FIG. 2B) for forming the image layer 54 in a matte tone by the ultraviolet light sources 114 (see FIG. 2B). In this case, it is considered that the surface of the image layer 54 becomes uneven (matte), causing diffused reflection of light to occur easily, for example. As a result, for example, in a state in which only the image layer 54 is formed on the application film 52, glitter and gloss peculiar to the pearl pigment in the application film 52 may be lost.

On the other hand, in the present embodiment, the printing apparatus 12 further forms a translucent layer 56, which is a layer with translucency covering the image layer 54, on the image layer 54 as shown in FIG. 3, for example. In this case, the printing apparatus 12 can be considered as, for example, doubling as a translucent layer forming unit. The operation of forming the translucent layer 56 by the printing apparatus 12 is an example of a translucent layer forming step.

The translucent layer 56 may cover only a part of the image layer 54, for example. In this case, for example, it can be considered that a portion of the image layer 54 covered with the translucent layer 56 is an example of the on-application-film ink layer. The translucent layer 56 covering the image layer 54 can also be considered as, for example, corresponding to the translucent layer 56 covering at least a part of the image layer 54. In the present embodiment, the translucent layer 56 can be considered as, for example, a layer of translucent ink formed on the image layer 54. The translucent layer 56 can also be considered as, for example, being formed on the image layer 54 so that the application film 52 is visually recognized through at least a part of the translucent layer 56 and the image layer 54. In the printing apparatus 12, for example, the inkjet head 112 for the clear ink can be suitably used as the inkjet head 112 for forming the translucent layer 56. In this case, for example, it can be considered that the clear ink is used as the material of the translucent layer 56. At the time of forming the translucent layer 56 in the present embodiment, the printing apparatus 12 forms the translucent layer 56 under the print condition to cure the ink ejected by the inkjet head 112 for forming the translucent layer 56 in a glossy tone by the ultraviolet light sources 114. With such a configuration, for example, the printing apparatus 12 can appropriately form the translucent layer 56. In this case, for example, the translucent layer 56 having higher surface smoothness (flatness) than the image layer 54 can be formed by forming the translucent layer 56 under the glossy-tone print condition. Therefore, according to the present embodiment, for example, it is possible to appropriately suppress the influence of diffused reflection of light or the like generated in the image layer 54 in a case where the translucent layer 56 is not formed. As a result, for example, it is possible to appropriately express the glitter, gloss, and the like peculiar to the pearl pigment in the medium 50 after forming the translucent layer 56.

Here, as described above as well, in the present embodiment, for example, by forming the image layer 54 on the application film 52 of the pearl application liquid and creating a printed matter so that the application film 52 is visually recognized through at least a part of the image layer 54, it is possible to create a printed matter with high designability in which a design expressed by the application film 52 of the pearl application liquid and a design expressed by the image layer 54 are combined. In this case, in order to prevent a loss of the glitter and the like peculiar to the pearl pigment, for example, the image layer 54 may be formed under the glossy-tone print condition instead of being formed under the matte-tone print condition. However, as the pearl pigment contained in the pearl application liquid, it is considered that, for example, a pigment having a particle size of about several tens um to several hundreds um is usually used. In this case, in the application film 52 of the pearl application liquid, it is considered that the surface of the application film 52 becomes rough due to the large size of the pearl pigment. As a result, at the time of forming the image layer 54 on the application film 52, the surface of the image layer 54 may become rough even if the ink dots are leveled (flattened), for example. In this case, for example, if the image layer 54 is formed under the glossy-tone print condition, the ink dots may spread in an unintended direction during the flattening of the ink dots due to the influence of the rough surface of the application film 52 as a base, and it may become difficult to appropriately form the layer of ink in a glossy tone. As a result, for example, smearing, disturbance, or the like may occur in an image to be expressed in the image layer 54, and a design to be expressed may be affected. On the other hand, in the present embodiment, for example, the ink dots landed on the application film 52 can be appropriately cured in a short time by forming the image layer 54 under the print condition to cure the ink in a matte tone. As a result, for example, even in a case where the surface of the application film 52 is rough, the ink can be more appropriately cured in an intended state.

As described above, in the present embodiment, the printing apparatus 12 further forms the translucent layer 56 on the image layer 54. With such a configuration, for example, the influence of diffused reflection of light or the like generated in the image layer 54 formed in a matte tone can be suppressed as described above. As a result, for example, the influence caused by forming the image layer 54 in a matte tone can be appropriately reduced, and a desired design can be more appropriately expressed. Therefore, according to the present embodiment, it is possible to appropriately create a printed matter with high designability while appropriately suppressing the influence of the surface state of the application film 52 of the pearl application liquid, for example. In this regard, the influence of the surface state of the application film 52 can be considered to be larger, for example, in a case where printing is performed with higher resolution in a relationship between the size of the pearl pigment and the printing resolution. Therefore, the above effect can be considered to be remarkable, for example, in a case where printing is performed with a resolution of about 600 dpi or more. This effect can be considered to be particularly large, for example, in a case where printing is performed with a resolution of about 1200 dpi or more.

Subsequently, supplementary explanation related to the above-described configuration, explanation of modified examples, and the like will be made. Hereinafter, for convenience of description, the configuration of the present embodiment may be regarded as including the modified examples described above or below. As described above, in the present embodiment, the application film 52 of the pearl application liquid is formed on the medium 50 using the application liquid ejection apparatus 14 and the application liquid curing apparatus 16 (see FIGS. 1A and 1B). In this case, the application liquid ejection apparatus 14 forms the application film 52 on the medium 50 by spreading, in the application region, the pearl application liquid ejected from the ejection unit 202 (see FIG. 1B) to the ejection position in the application region. Therefore, according to the present embodiment, the pearl application liquid can be appropriately applied to the medium 50 without using, for example, a printing plate for screen printing. As a result, for example, the labor, expense, and the like required for applying the pearl application liquid can be appropriately reduced. In this case, for example, the pearl application liquid can be easily and appropriately applied to various media 50.

As the medium 50, for example, it is also conceivable to use a medium (roll medium) wound in a roll shape. The medium wound in a roll shape can be considered as, for example, a medium having an indefinite length in a direction orthogonal to the width direction. The medium wound in a roll shape can also be considered as, for example, a medium that is provided in a state of being wound in a roll shape and sequentially unwound and used as necessary. In this case, for example, in the printing apparatus 12, the transporting mechanism 106 (see FIG. 2A) unwinds and transports the medium 50 from the medium 50 wound in a roll shape. As a result, for example, the printing apparatus 12 forms the image layer 54 and the translucent layer 56 on the application film 52 of the pearl application liquid while transporting the medium 50.

As described above as well, in the present embodiment, the printing apparatus 12 forms the layer of ink such as the image layer 54 on the application film 52 formed on the medium 50. In this regard, as a method for forming the layer of ink by the printing apparatus 12 on the medium 50 on which the application film 52 of the pearl application liquid is formed, for example, it is conceivable to form the layer of ink on a side opposite to the surface of the medium 50 on which the application film 52 is formed, instead of forming the layer of ink on the application film 52.

Also in this case, a design in which the application film 52 of the pearl application liquid and the layer of ink are combined can be expressed by using the translucent medium 50, for example. However, in this case, a problem may occur in the printing operation depending on the configuration of the printing apparatus 12, for example. More specifically, in a case where the transporting mechanism 106 is used to transport the medium 50 as in the printing apparatus 12 of the present embodiment, it is necessary for the transporting mechanism 106 to transport the medium 50 with, for example, the surface on which the application film 52 is formed facing downward in order to form the layer of ink on the side opposite to the surface of the medium 50 on which the application film 52 of the pearl application liquid is formed. In this case, for example, a frictional force generated between the medium 50 and the table unit 104 (FIG. 2A) supporting the medium 50 increases, whereby transport failure such as occurrence of a jam is likely to be caused. For example, the pearl pigment may fall off from the application film 52 due to rubbing between the table unit 104 and the application film 52. For the application film 52 of the pearl application liquid, for example, slight stickiness may remain even in a state after curing. In such a case, for example, when the medium 50 is transported with the surface on which the application film 52 is formed facing downward, transport failure or the like is particularly likely to occur. On the other hand, in the case of forming the layer of ink such as the image layer 54 on the application film 52 as in the present embodiment, the medium 50 can be more appropriately transported in the printing apparatus 12. As a result, for example, a printed matter with high designability can be more appropriately created.

In the printing system 10, for example, regarding the configuration shown in FIG. 1A, it is also conceivable to use an apparatus having the functions of a plurality of apparatuses. More specifically, in this case, for example, it is conceivable to use one apparatus that functions as the printing apparatus 12, the application liquid ejection apparatus 14, and the application liquid curing apparatus 16. With such a configuration, for example, one apparatus can appropriately perform the application of the pearl application liquid and the formation of the layer of ink with respect to the medium 50. Furthermore, in this case, by forming the layer of ink such as the image layer 54 on the application film 52 of the pearl application liquid, the application of the pearl application liquid and the formation of the layer of ink can be appropriately performed with respect to the medium 50 without performing the operation of turning over the medium 50, for example. Such an apparatus can be considered as, for example, an apparatus including an ejection unit for the pearl application liquid and an inkjet head for forming the layer of ink. In this case, the apparatus further includes, for example, a transporting mechanism that transports the medium along a path passing through a position where the ejection unit ejects the pearl application liquid and a position where the inkjet head ejects the ink. Also in this case, for example, various media such as a medium wound in a roll shape can be suitably used as the medium 50.

In a case where the image layer 54 and the like are formed on the application film 52 of the pearl application liquid as in the present embodiment, it is possible to appropriately express a design obtained by combining a design expressed by the application film 52 and a design of an image drawn on the image layer 54 using the non-translucent medium 50, for example. It is also conceivable to use, for example, the translucent medium 50 according to a design to be expressed in a printed matter. With such a configuration, for example, it is possible to create a printed matter or the like in which the application film 52 of the pearl application liquid can be visually recognized even from the side opposite to the surface on which the application film 52 is formed. As a result, for example, a printed matter with higher designability can be appropriately created. For example, a colorless and translucent medium can be suitably used as the translucent medium 50. For example, a translucent film can also be suitably used as the translucent medium 50. The medium 50 is not limited to the medium wound in a roll shape, and may be a leaf-like medium having a fixed length in the direction orthogonal to the width direction. In this case, for example, it is conceivable to use a resin plate such as an acrylic plate as the medium 50.

As described above as well, in the present embodiment, the pearl pigment and the pearl application liquid are examples of the effect pigment and the effect pigment-containing liquid. The effect pigment and the effect pigment-containing liquid are examples of the functional powder and the functional powder-containing liquid. The pigment such as the effect pigment can also be considered as, for example, an example of the powder contained in the application liquid. In a modified example of the configuration and operation of the printing system 10, for example, it is also conceivable to use an application liquid (effect pigment-containing liquid or functional powder-containing liquid) containing an effect pigment or a functional powder other than the pearl pigment. In this case, it is conceivable to use an application liquid containing an effect pigment other than the pearl pigment instead of the pearl application liquid described above. In this case, for example, it is conceivable to use a pigment exhibiting a special color by reflection, absorption, or the like of light as the effect pigment. For example, a scaly pigment can be suitably used as these effect pigments. More specifically, as the effect pigment other than the pearl pigment, for example, it is conceivable to use a lame pigment or a glitter pigment. As the lame pigment, for example, it is conceivable to use a pigment composed of a resin film on which aluminum is deposited, a metal foil such as an aluminum foil, a multilayer film, or the like. For example, a PET film can be suitably used as the resin film. For example, a configuration in which a plurality of thin resin films are layered can be suitably used as the multilayer film. As the lame pigment, for example, it is conceivable to use a pigment having a particle size of about several hundreds um to several mm (for example, about 100 μm to 3 mm). For example, a pigment having a configuration in which the particle size of the lame pigment is increased can be suitably used as the glitter pigment. In this case, as the glitter pigment, for example, it is conceivable to use a pigment having a particle size of several mm or more (for example, 3 mm or more). As the application liquid, for example, it is also conceivable to use a liquid containing various functional powders other than those described above. As the functional powder, for example, it is also conceivable to use various functional powders (pigments) other than the effect pigment. More specifically, as the functional powder, for example, it is also conceivable to use a phosphorescent, antifouling, or conductive powder. As the functional powder, for example, it is also conceivable to use a material such as a functional powder or filler that imparts other mechanical or chemical properties.

Even in the case of using the application liquid containing such various functional powders, for example, the application liquid can be appropriately applied to the medium by using the printing system 10 having the identical or similar configuration to that described above.

In the case of using the application liquid containing various functional powders, it is preferable to appropriately adjust the viscosity of the application liquid according to, for example, the types, particle sizes, or the like of the functional powders contained in the application liquid. In the case of using an application liquid other than the pearl application liquid, for example, it is conceivable to form the layer of ink on the application film of the application liquid by the printing apparatus 12 in a manner identical or similar to that at the time of forming the image layer 54 and the translucent layer 56. With such a configuration, for example, the layer of ink can be appropriately formed on the application film of the application liquid containing various functional powders. As a result, for example, a printed matter with high designability can be appropriately created.

In the present embodiment, the translucent layer 56 can also be considered as, for example, a coating layer that covers the surface of the printed matter. In this case, the ink used for forming the translucent layer 56 can also be considered as, for example, a coating agent to be a material of the coating layer. In a modified example of the configuration of the printing system 10, it is also conceivable to form the translucent layer 56 by, for example, a method other than the method of forming the layer of ink with the printing apparatus 12. In this case, for example, the translucent layer 56 is formed by applying the coating agent to be the material of the translucent layer 56 onto the image layer 54 using an apparatus other than the printing apparatus 12 or a tool. As a result, for example, a layer having a surface smoother than the image layer 54 is formed as the translucent layer 56. More specifically, in this case, it is conceivable to form the translucent layer 56 using, for example, a spray that ejects the coating agent in a mist form. In this case, the apparatus or tool used for applying the coating agent can also be considered as a configuration included in the printing system 10. This apparatus or tool can be considered as, for example, an example of the translucent layer forming unit. Also with such a configuration, for example, the translucent layer 56 can be appropriately formed on the image layer 54. As a result, for example, the influence of diffused reflection of light or the like generated in the image layer 54 formed in a matte tone can be suppressed. For example, a colorless and translucent clear coating agent can be suitably used as the coating agent. The translucent layer 56 may be formed not by applying the material of the translucent layer 56, but by sticking a film (thin film) such as a laminate film, for example. Also in this case, the translucent layer 56 can be considered as, for example, becoming a layer with a smoother surface than the image layer 54. More specifically, in this case, for example, after the image layer 54 is formed by the printing apparatus 12, a translucent film is stuck on the image layer 54 to form the translucent layer 56. In this case, an apparatus or a tool used for sticking the film can also be considered as a configuration included in the printing system 10. This apparatus or tool can be considered as, for example, an example of the translucent layer forming unit. Also with such a configuration, for example, the translucent layer 56 can be appropriately formed on the image layer 54. As a result, for example, the influence of diffused reflection of light or the like generated in the image layer 54 formed in a matte tone can be suppressed.

The present disclosure can be suitably used, for example, for a manufacturing method for a printed matter.

What is claimed is:

1. A manufacturing method for a printed matter to create a printed matter in which a functional powder-containing liquid that is a liquid containing a functional powder that is a powder having a predetermined function is applied to at least a part of a medium, the manufacturing method comprising:
a post-application medium preparing step of preparing a post-application medium that is the medium on which an application film that is a film formed by applying the functional powder-containing liquid is at least partially formed;
an on-application-film ink layer forming step of forming an on-application-film ink layer that is a layer of ink stacked on the application film by ejecting ink onto the application film using a printing apparatus; and
a translucent layer forming step of forming a translucent layer that is a layer with translucency covering the on-application-film ink layer, wherein
the printing apparatus includes
an inkjet head that ejects ink by inkjet method, and
a curing unit that cures the ink ejected by the inkjet head, and
in the on-application-film ink layer forming step, the printing apparatus is caused to form the on-application-film ink layer under a print condition to cure the ink ejected by the inkjet head in a matte tone by the curing unit.

2. The manufacturing method for a printed matter according to claim 1, wherein
in the on-application-film ink layer forming step, the on-application-film ink layer is formed so that the application film of the functional powder-containing liquid is visually recognized through the on-application-film ink layer in at least a part of the on-application-film ink layer, and
in the translucent layer forming step, the translucent layer is formed to reduce an influence of diffused reflection of light generated in the on-application-film ink layer.

3. The manufacturing method for a printed matter according to claim 1, wherein
the inkjet head ejects an ultraviolet-curable ink,
the curing unit is an ultraviolet light source that generates ultraviolet light,
the printing apparatus further includes a main scan driving unit that causes the inkjet head to perform a main scan of ejecting ink while relatively moving with respect to the medium in a main scanning direction set in advance,
in the main scan, the ultraviolet light source emits ultraviolet light toward the medium while relatively moving with respect to the medium together with the inkjet head, and
in the on-application-film ink layer forming step, the ultraviolet light source irradiates the ink ejected by the inkjet head in one main scan with ultraviolet light in the same main scan to cure the ink in a matte tone.

4. The manufacturing method for a printed matter according to claim 1, wherein
the printing apparatus includes
an on-application-film ink layer head that is the inkjet head ejecting ink to be a material of the on-application-film ink layer, and
a translucent layer head that is the inkjet head ejecting ink to be a material of the translucent layer,
in the on-application-film ink layer forming step, the ink ejected from the on-application-film ink layer head is cured in a matte tone by the curing unit to form the on-application-film ink layer, and
in the translucent layer forming step, the ink ejected from the translucent layer head is cured in a glossy tone by the curing unit to form the translucent layer.

5. The manufacturing method for a printed matter according to claim 1, wherein in the translucent layer forming step, the translucent layer is formed by applying a coating agent to be a material of the translucent layer onto the on-application-film ink layer.

6. The manufacturing method for a printed matter according to claim 1, wherein in the translucent layer forming step, the translucent layer is formed by sticking a translucent film on the on-application-film ink layer.

7. The manufacturing method for a printed matter according to claim 1, wherein
the medium wound in a roll shape is used, and
the printing apparatus further includes a transporting mechanism that unwinds and transports the medium from the medium wound in a roll shape.

8. The manufacturing method for a printed matter according to claim 1, wherein the functional powder-containing liquid contains a pearl pigment as the functional powder.

9. A printing system for creating a printed matter in which a functional powder-containing liquid that is a liquid containing a functional powder that is a powder having a predetermined function is applied to at least a part of a medium, the printing system comprising:
a printing apparatus, configured to form an on-application-film ink layer that is a layer of ink stacked on an application film that is a film formed by applying the functional powder-containing liquid, on a post-application medium that is the medium on which the application film is at least partially formed by ejecting ink onto the application film; and
a translucent layer forming unit, configured to form a translucent layer that is a layer with translucency covering the on-application-film ink layer, wherein
the printing apparatus includes
an inkjet head that ejects ink by inkjet method, and
a curing unit that cures the ink ejected by the inkjet head, and
the printing apparatus forms the on-application-film ink layer under a print condition to cure the ink ejected by the inkjet head in a matte tone by the curing unit.
